(19) United States
(12) Patent Application Publication
(10) Pub. No.: US 2008/0192757 A1
(43) Pub. Date: Aug. 14, 2008

(54) System and method for enabling transfer of data and communication between individuals

(76) Inventor: Barak Hirchson, Tel-Aviv (IL)

Correspondence Address: Martin D. Moynihan;PRTSI, Inc., P.O. Box 16446, Arlington, VA, 22215, US

(21) Appl. No.: 11/703,755

(22) Filed: Feb. 8, 2007

(51) Int. Cl. H04L 12/28

(52) U.S. Cl. 370/401

(57) ABSTRACT

A system for relaying data from a first subject to a second subject is provided. The system includes a database server configured for receiving data associated with an identifier from the first subject operating a first user client connected to a first communication network and alerting the second subject to the existence of the data via a second user client connected to a second communication network.

### FIELD AND BACKGROUND OF THE INVENTION

The present invention relates to a system and method for enabling transfer of data and communication between individuals.

Communications networks such as the Internet and cellular telephone networks allow users to communicate and exchange information.

The Internet is a computer network arranged to allow the easy and robust exchange of information between computer users, such users access the Internet via Internet Service Providers (ISPs). The Internet allows users to download, view and share information, in the form of text, graphics, video, sounds, and other forms of data. Various systems are in use for communicating electronically over the Internet. E-mail systems are particularly popular for exchanging data. In a conventional e-mail system, a sender composes an e-mail message using an e-mail client program, addressing the e-mail using the intended recipients e-mail address which is used as the standard identifier for email communication, much in the same way that a string of numbers is used as an identifier for a telephony network.

Typically e-mail addresses are composed of a combination of the recipient's identity, such as some portion of the users' name, combined with a domain portion, which designates the system hosting the mailbox the recipient uses to receive e-mail. When the sender sends the e-mail to the recipient using a system such as Simple Mail Transfer Protocol (SMTP), the domain portion of the e-mail address is resolved to an Internet Protocol (IP) address using a dynamic name server (DNS) system. The IP address is used to route the e-mail to the destination server and the initial portion of the address is used to locate the recipient's mailbox on the destination server.

Due to the complexity typically associated with email addressing schemes, a sender must be in possession of both the personal and the domain portions of the e-mail address in order to correctly address email to the intended recipient. To further complicate matters, individuals frequently switch ISPs due to cost savings, change of employment and the like. Thus, although most users store frequently utilized email addresses in their email clients' address book, there remain cases in which a user is not in possession of an email address of an individual.

Another problem with email data transfer involves spam filtering. Since most users employ some form of spam filtering either at the email client level or the ISP level, email messages from new senders might be labeled as spam and thus not viewed by an intended recipient.

At present day, cellular telephones have become the most popular personal communications/data storage devices. It is estimated that in 2006 one of every four individuals on the planet owns and operates a cellular telephone; in 2006 alone, nearly one billion handsets were sold worldwide.

The ubiquity of cellular communication has resulted in that cellular telephone numbers are gradually becoming the most utilized identifier for individuals.

It is thus conceivable that an individual is more likely to be in possession of an individuals cellular telephone number and not email address or other identifiers.

There is thus a widely recognized need for, and it would be highly advantageous to have, a system and method which enable a user to send data to a recipient through a communication network without knowing the recipients' identifier for that specific communication network.

### SUMMARY OF THE INVENTION

According to one aspect of the present invention there is provided A system for relaying data from a first subject to a second subject comprising a database server being configured for receiving data associated with an identifier from the first subject operating a first user client connected to a first communication network and alerting the second subject to the existence of the data via a second user client connected to a second communication network.

According to further features in preferred embodiments of the invention described below, the database server is further configured for enabling the second subject to view the data.

According to still further features in the described preferred embodiments the enabling is effected by providing the second subject with a dedicated user account in the database server.

According to still further features in the described preferred embodiments the dedicated user account is an email account.

According to still further features in the described preferred embodiments the email account is generated upon request for viewing the data by the second user.

According to still further features in the described preferred embodiments the first communication network is the Internet and the second communication network is a cellular network.

According to still further features in the described preferred embodiments the identifier is a telephone number of the second subject.

According to still further features in the described preferred embodiments the telephone number is a cellular telephone number and the alerting is effected via a text message.

According to still further features in the described preferred embodiments the data includes a text file and/or a media file.

According to another aspect of the present invention there is provided a method of relaying data from a first subject to a second subject comprising receiving data associated with an identifier from the first subject operating a first user client connected to a first communication network and alerting the second subject to the existence of the data via a second user client connected to a second communication network.

According to still further features in the described preferred embodiments the method further comprises enabling the second subject to view the data.

According to still further features in the described preferred embodiments the enabling is effected by providing the second subject with access to a dedicated user account on a database server.

According to still further features in the described preferred embodiments the dedicated user account is an email account.

According to still further features in the described preferred embodiments the email account is generated in the database server upon request for viewing the data by the second user.

According to still further features in the described preferred embodiments the first communication network is the Internet and the second communication network is a cellular network.

According to still further features in the described preferred embodiments the identifier is a telephone number of the second subject.

According to still further features in the described preferred embodiments the telephone number is a cellular telephone number and the alerting is effected via a text message.

According to still further features in the described preferred embodiments the data includes a text file and/or a media file.

According to yet another aspect of the present invention there is provided a system for initiating communication between a first subject to a second subject comprising a database server being configured for receiving a communications request associated with an identifier from the first subject operating a first user client connected to a communication network, the identifier not being associated with the communication network, and relaying to the second subject the communication request via a second user client connected to the communication network.

According to still further features in the described preferred embodiments the communication network is a cellular network and the identifier is an email address of the second subject.

The present invention successfully addresses the shortcomings of the presently known configurations by providing a system and method for enabling use of global identifiers for establishing communication, such as for example, email communication.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is a box diagram illustrating one embodiment of the system of the present invention.

### DESCRIPTION OF THE PREFERRED EMBODIMENTS

The present invention is of a system which enables users to establish communication with, and send data to, other users.

The principles and operation of the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

With the advent of digital communication, individuals can now utilize any one of several communication networks in order to communicate information to other individuals.

Due to the fact that each communication mode requires a unique and specific identifier which is composed of a complex string of numbers and/or letters, to establish communication, users typically rely upon the contact information stored in a communication device designed for use with a specific communication network. Thus, email communication is typically effected using a computer and an email program which stores personal contact information in the form of an email address, while cellular communication is effected using a cellular telephone which stores personal contact information in the form of cellular telephone numbers.

Although stored contact information frees a user from having to commit to memory complex identifiers, it does not enable a user to use a single identifier in all modes of communication.

Although prior art systems have attempted to solve this problem (see, for example, U.S. patent application Ser. No. 11/181,853), such systems do not bridge between existing communication networks such as the internet and cellular networks, but rather provide a portal through which communication can be established using a single and memorable identifier.

While reducing the present invention to practice, the present inventors have devised a system which enables bridging between different communication networks to thereby enable a user to, for example, send an email to a recipient while addressing the email to the recipient's cellular telephone number.

Thus, according to one aspect of the present invention, there is provided a system for relaying data from a first subject to a second subject.

The present system includes a database server which is configured for receiving data associated with an identifier from the first subject operating a first user client connected to a first communication network. The system of the present invention is further configured for alerting the second subject to the existence of the data via a second user client connected to a second communication network.

As used herein, the term data refers to any form of digital data, which can be compressed or encrypted. Examples include text, image, video, voice and the like.

As used herein the term “identifier” refers to a string of characters (e.g. letter, numbers) which is used as a unique identifier for establishing communication using a specific communication network or for identifying a specific individual. For example, an identifier can be an email address which is composed of a users' name and a domain name separated by the ‘at’ mark (e.g. johndoe@network.com), or a string of numbers identifying a phone number of an individual, including area code and optionally a country code. Other identifiers can be a street address, a name (first and last names) and the like.

The present system is designed for utilizing such identifiers for establishing communication between users, even in cases where the users are operating user clients connected to different communication networks.

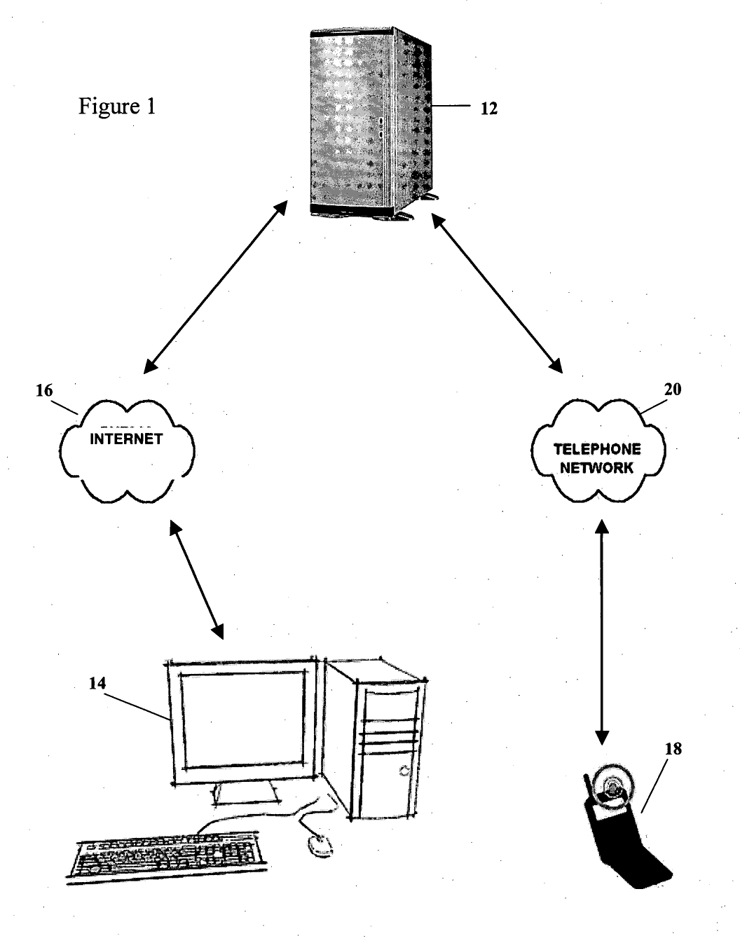

For example, as is shown in FIG. 1, the present system (which is referred to herein as system 10) enables a user of user client 14 (which is an email client operating a computer connected to network 16 in this case) to send an email message with or without attachments to a user of user client 18 (which is a cellular telephone operating a cellular telephone connected to network 20 in this case) by addressing the email to a the number of the cellular telephone. As is further described below the email addressed with using a cellular telephone number is received and processed by database server 12 of system 10.

As used herein, the phrase “database server” refers to a computing platform (e.g. personal computer, workstation or mainframe) which is capable of receiving and sending data via one or more communication network types and is configured for storing and processing data.

As used herein, the phrase “user client” refers to any communication-capable computing platform including, but not limited to, a computer, such as a personal computer (PC) having an operating system such as DOS™, Windows™, OS/2™, Linux or Apple™ OS X™; computers having JAVA-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones, Smartphones, Web TVs and the like.

As used herein, the phrase “communication network” refers to any communication network, including, but not limited to, the Internet, Cellular telephone networks, landline telephone networks, satellite networks and the like.

Hereinafter, the term “Web browser” or “browser” refers to any software application which can display text, graphics, or both, from Web pages on World Wide Web sites. Examples of Web browsers include, Internet Explorer, Opera, FireFox, Safari and the like.

Hereinafter, the term “Web site” is used to refer to at least one Web page or a plurality of Web pages, virtually connected to form a coherent group of interlinked documents.

Hereinafter, the term “Web page” refers to any document written in a mark-up language including, but not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator).

Hereinafter, the term “email” refers to asynchronous transmission of messages by using computers and data-communication networks. The phrase “email client” refers to a software application which is capable of sending and receiving email messages. E-mail clients typically use the POP3 (Post Office Protocol v3) or the IMAP (Internet Message Access Protocol) protocol to retrieve e-mail messages from an e-mail server. E-mail clients use the SMTP (Simple Mail Transfer Protocol to send e-mail messages to e-mail servers. Examples of email clients include, Microsoft's' Outlook and Outlook Express, Apples' Mail and Qualcomm's Eudora.

System 10 can utilize any one of several dedicated communication schemes in order to facilitate such communication.

According to one approach (shown in FIG. 1), email client 14 includes a plug in application which functions in routing email messages addressed to, for example, a cellular telephone number from an ISP server of the sender to database server 12. Such a plug-in can function in identifying any string of characters which is entered in an address box of an email client and does not represent a valid email address and routing any email message addressed with such a string of characters to database server 12. The plug-in can achieve this by simply replacing the string of characters with an email address of database server 12 while appending the string of characters entered by the user to the sent email message. Database server can then receive the message and process it as described hereinunder.

Alternatively, a user can utilize a Web-based email client hosted by database server 12 to compose and send an email message.

In any case, once a message is received by database server 12, it is processed according to the identifier used to address the message and stored in an in-box associated with the identifier.

Processing depends on the data stored by database server with respect to the recipient. For example, if databases server 12 is in possession of the email address of the recipient, it can simply forward the email message to the recipients' email address.

Although database server 12 can also forward the email message directly to user client 18, such forwarding is only desirable in cases where simple text emails are used since email messages with embedded or attached media files cannot be optimally viewed by cellular telephones.

If the email address of the recipient is not available to database server 12 it can either send a text message (e.g. SMS) to the recipient alerting the recipient of the presence of the email message asking the recipient to reply with a text message including an email address to which the message can be forwarded.

Alternatively, database server can provide the recipient with instruction as to how to go about receiving the email message addressed thereto. For example, database server can generate an email account for the user using a unique identifier (e.g. the cell phone number used for addressing) in an email addressing scheme dedicated to database server 12. The email message would then be retrievable by the recipient using an email client or by accessing a web page portal of database server 12.

It will be appreciated that since addressing mistakes are possible as is the chance for spam email, database server 12 will ask the recipient to confirm receipt of the email message (via, for example, text messaging) prior to forwarding of email or generation of a dedicated email account.

Once a user accesses the email stored by database server 12 using the dedicated account generated for the user, database server 12 can request additional information from the user which can be used in generating the account.

Such information can include contact information (e.g. email address, telephone number, home address), as well as personal information (e.g. date of birth, height weight, hobbies, profession which can be used to generate a personal profile. Database server can utilize such information as email addressing identifiers. For example, now that a user account with database server 12 can be identified by a landline telephone number or by a street address. Sender using an email application provided with the aforementioned plug-in or using the web based mail described above can now use other identifiers related to the user, such as data of birth and name in order to address an email message thereto. In such cases, database server 12 simply stores incoming mail in the inbox of the user account on database server 12. The user can then receive the email by simply logging into database server 12 using an email client or the web based portal described above. Database 12 can also automatically (at the request of the user) download incoming mail messages in other email accounts of the user, such that all incoming mail of a user form a plurality of email accounts can be viewed simultaneously.

Thus, in one configuration of system 10, database server generates an email account dedicated to recipient of an email addressed to a cellular telephone number thereof. It will be appreciated that in cases where a user having a dedicated account with database server 12 has another email account which is used more frequently (e.g. a work account), database server 12 can be instructed by the user to forward all incoming email to that account or vise versa.

Since system 10 processes and communicates information to the user, it can also be configured to provide the user with information of value to the user or advertisers. Such information can include promotions, employment opportunities, news and the like. Such information can be provided in accordance with the profile of the user as stored by database server 12 or not.

For example, database server can insert advertisements into mail messages addressed to the user; such advertisements can be selected according to user profile. Approaches for targeting content to specific users according to their user profiles are known in the art and thus no further description of such approaches are provided herein.

Although the above described configuration of system 10 is designed for communicating email messages without necessitating email identifiers, it should be noted that system 10 can also be used for facilitating other forms of communication.

For example, in cases where a user has an email address or date of birth and name of an individual and yet desires to contact the individual through a cellular network, the user can send such an identifier to database server 12 (via, for example, text messaging using a cellular telephone) along with a request to establish cellular communication with the individual. If the individual has an account with database server 12 which includes cellular telephone number information, then database server 12 can send the individuals; cellular telephone a request for communication from the sender (via, for example, a text message). If the individual accepts the request for communication from the user, database server can initialize communication and then hand it off to the cellular communication provider of the user. If the individual declines communication is not initialized and the user is alerted accordingly.

It will be appreciated that once system 10 of the present invention collects a plurality of user profiles, each containing information specific to a user, such profiles can be used to establish a user communities which can categorized and subdivided into subpopulations according to criteria such as user occupation, user interests, geographical locations, hobbies etc.

Users of such communities can be provided with user or community-specific promotions, advertisements and the like. System 10 can also provide such users and communities with trading and transaction systems which can be used within the confines of system 10 and its communities.

Additional services which can be provided to users and communities of system 10 include, but are not limited to, image and video sharing, shared whiteboard functionality, dating services, credit account functionality using cell phone identities and the like.

It will be appreciated that the functionality of system 10 of the present invention can be implemented at any level including corporate and small business levels.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for relaying data from a first subject to a second subject comprising a database server being configured for receiving data associated with an identifier from the first subject operating a first user client connected to a first communication network and alerting the second subject to the existence of said data via a second user client connected to a second communication network.

2. The system of claim 1, wherein said database server is further configured for enabling the second subject to view said data.

3. The system of claim 2, wherein said enabling is effected by providing the second subject with a dedicated user account in said database server.

4. The system of claim 3, wherein said dedicated user account is an email account.

5. The system of claim 4, wherein said email account is generated upon request for viewing said data by the second user.

6. The system of claim 1, wherein said first communication network is the Internet and said second communication network is a cellular network.

7. The system of claim 1, wherein said identifier is a telephone number of the second subject.

8. The system of claim 7, wherein said telephone number is a cellular telephone number and said alerting is effected via a text message.

9. The system of claim 1, wherein said data includes a text file and/or a media file.

10. A method of relaying data from a first subject to a second subject comprising receiving data associated with an identifier from the first subject operating a first user client connected to a first communication network and alerting the second subject to the existence of said data via a second user client connected to a second communication network.

11. The method of claim 10, further comprising enabling the second subject to view said data.

12. The method of claim 11, wherein said enabling is effected by providing the second subject with access to a dedicated user account on a database server.

13. The method of claim 12, wherein said dedicated user account is an email account.

14. The method of claim 13, wherein said email account is generated in said database server upon request for viewing said data by the second user.

15. The method of claim 10, wherein said first communication network is the Internet and said second communication network is a cellular network.

16. The method of claim 10, wherein said identifier is a telephone number of the second subject.

17. The method of claim 16, wherein said telephone number is a cellular telephone number and said alerting is effected via a text message.

18. The method of claim 10, wherein said data includes a text file and/or a media file.

19. A system for initiating communication between a first subject to a second subject comprising a database server being configured for receiving a communications request associated with an identifier from the first subject operating a first user client connected to a communication network, said identifier not being associated with said communication network, and relaying to the second subject said communication request via a second user client connected to said communication network.

20. The system of claim 19, wherein said communication network is a cellular network and said identifier is an email address of the second subject.
